(19) United States
(12) Patent Application Publication
(10) Pub. No.: US 2024/0406604 A1
(43) Pub. Date: Dec. 5, 2024

(54) AUTOMATIC CONNECTION DISCOVERY AND CONNECTION VERIFICATION

(71) Applicant: Cisco Technology, Inc., San Jose, CA (US)

(72) Inventors: Valerio Viscardi, Paderno Dugnano (MI) (IT); Aldo Aprile, Milano (MI) (IT)

(21) Appl. No.: 18/327,233

(22) Filed: Jun. 1, 2023

(51) Int. Cl. H04Q 11/00

(52) U.S. Cl. CPC H04Q 11/0067; H04Q 2011/0073; H04Q 2011/0083

(57) ABSTRACT

A centralized controller automatically detects connections in a network system of network elements. The centralized controller provides a measurement schedule to network elements in the network system. The measurement schedule indicates a predetermined time to sample optical ports of each network element. The centralized controller obtains measurement results from each network element, with each particular measurement result being associated with an optical port of a network element. The centralized controller then cross-correlates the measurement results to determine one or more direct connections between optical ports on corresponding pairs of network elements. A notification indicating the one or more direct connections is provided to at least one administrative device.

### TECHNICAL FIELD

The present disclosure relates to computer network configuration, specifically to detection/verification of connected ports of network elements or ports within a network element.

### BACKGROUND

Discovery and verification of network cable connections, especially at the scale of data centers, presents an avenue for human error because it is typically a manual process. Connection verification typically assumes that the cabling has been done according to a predetermined plan, and the network connections are verified according to the predetermined plan. Connection discovery typically does not have a predetermined plan for specific connections, and a connection discovery system actively checks all available ports to identify their connectivity. Operational boundaries with different cabling and network procedures may further exacerbate the potential for the introduction of error into network connections.

In particular, connection verification/discovery for network elements that connect the Internet Protocol (IP) layer with optical networking presents an issue. The analog link between the IP interface and the Optical Line Systems (OLS), such as Reconfigurable Optical Add/Drop Multiplexer (ROADM), Fixed Optical Add/Drop Multiplexer (FOADM), multiplexer (MUX) and demultiplexer (DMX) ports, does not allow the OLS to terminate the digital signal for in-band connection discovery and verification.

### BRIEF DESCRIPTION OF THE DRAWINGS

FIG. 1 is simplified block diagram of a network system configured to automatic connection discovery/verification, according to an example embodiment.

FIG. 2A illustrates a network controller providing a measurement schedule to a plurality of network elements, according to an example embodiment.

FIG. 2B illustrates the network controller collecting the measurement results that the network controller to automatically determine which pairs of optical ports are connected, according to an example embodiment.

FIG. 3 illustrates signals that are sampled at the same predetermined time from two optical ports, according to an example embodiment.

FIG. 4A illustrates the cross-correlation of sampled signals from two optical ports that are connected to each other, according to an example embodiment.

FIG. 4B illustrates the cross-correlation of sampled signals from two optical ports that are not connected to each other, according to an example embodiment.

FIG. 5 illustrates the determination of which ports are connected based on the peak value of a cross-correlation between sampled signal measurements, according to an example embodiment.

FIG. 6A illustrates a sampled signal measurement from a first port, according to an example embodiment.

FIG. 6B illustrates a sampled signal measurement from a connected port with a time offset, according to an example embodiment.

FIG. 6C illustrates the effect of sampling time mismatch on the cross-correlation peak of measurement results, according to an example embodiment.

FIG. 7 is a flowchart illustrating operations performed by a network controller to automatically determine direct connections between optical ports of network elements, according to an example embodiment.

FIG. 8 is a flowchart illustrating operations performed by a network element to sample a signal from one or more optical ports at a predetermined time to enable a network controller to automatically determine connections of the one or more optical ports, according to an example embodiment.

FIG. 9 is a block diagram of a computing device that may be configured to perform the techniques presented herein, according to an example embodiment.

### DETAILED DESCRIPTION

### Overview

A computer-implemented method is provided to automatically detect connections in a network system of network elements. The method includes providing a measurement schedule to a plurality of network elements. The measurement schedule indicates a predetermined time to sample optical ports of each network element in the plurality of network elements. The method also includes obtaining a plurality of measurement results from the plurality of network elements, with each particular measurement result being associated with an optical port of a network element. The method further includes cross-correlating the plurality of measurement results to determine one or more direct connections between optical ports on corresponding pairs of network elements. The method also includes providing a notification, which indicates the one or more direct connections, to at least one administrative device.

### Example Embodiments

The techniques presented herein provide a mechanism to automatically discover/verify connectivity between any two optical ports in a network using optical power measurement points (e.g., photodiodes) that are typically available in many network elements. In one example, the system provides automatic discovery of connections in Routed Optical Networking (RON) of the interconnection between routers and Dense Wavelength Division Multiplexing (DWDM) elements. However, the techniques may also apply to any other interconnection in the network.

Software Defined Networking (SDN) has become an important network architecture in recent years to provide flexibility in network deployments. An SDN Hierarchical controller typically determines network element configurations and pushes the appropriate configuration to individual network elements through domain controllers (e.g., for the IP domain or the optical domain). SDN architectures typically do not cover the discovery and/or verification of interconnections between domains. These inter-domain interconnections are usually manually configured and prone to human error, which the techniques described herein are designed to mitigate. The specific examples described herein apply the automatic connection discovery/verification in an SDN deployment through a hierarchical controller, but other embodiments may exist in which a centralized controller uses the techniques provided herein to automatically discover and/or verify direct connections between ports of a transmission network system. For instance, a Network Management System (NMS) may apply similar techniques to automatically discover and/or verify connections in a non-SDN enabled network.

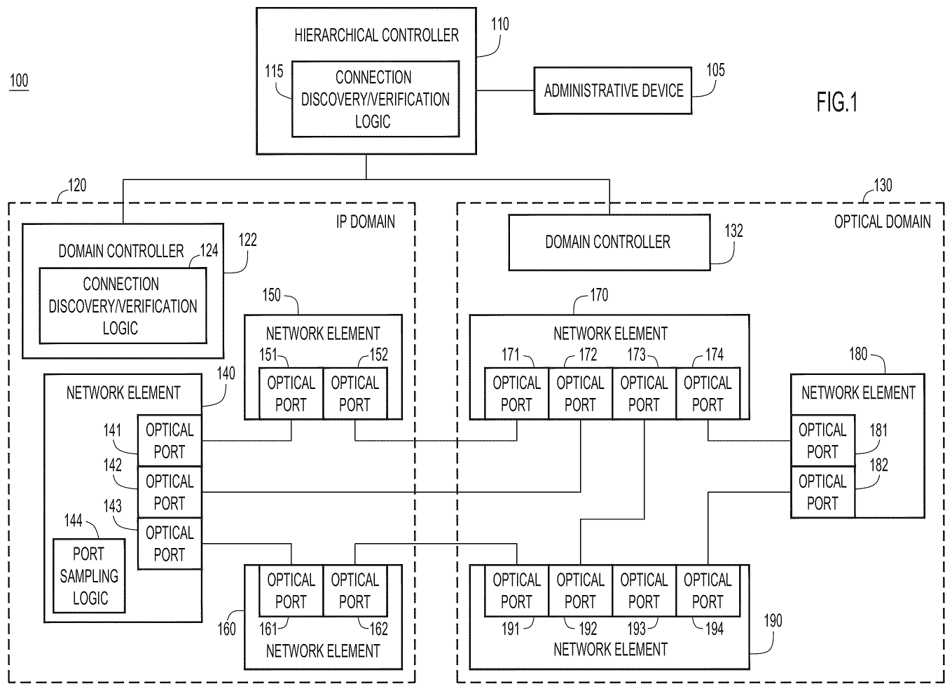

Referring now to FIG. 1, a connection discovery/verification system 100 is configured to automatically detect direct connections between optical ports in a computer network. The system 100 includes an administrative device 105 that may be used by an administrator to adjust one or more network elements in the system 100. The system 100 also includes a hierarchical controller 110 with connection discovery/verification logic 115 that enables the hierarchical controller 110 to perform the techniques described herein. In one example, the connection discovery/verification logic 115 enables the hierarchical controller 110 to schedule signal sampling across multiple network elements and cross-correlate the sampled signals to determine direct connections.

The system 100 includes a domain 120 (e.g., an IP domain) and a domain controller 122 with connection discovery/verification logic 124. In one example, the domain 120 may be an IP domain with network elements that communicate through IP messages. The connection discovery/verification logic 124 enables the domain controller 122 to mediate messages between the hierarchical controller 110 and network elements in the domain 120. The system 100 also includes a domain 130 (e.g., an optical domain) and a domain controller 132. The domain controller 132 may have similar logic to the domain controller 122 for mediating messages between the hierarchical controller 110 and the network elements in the domain 130.

The domain 120 includes a network element 140 with optical ports 141, 142, and 143. The network element also includes port sampling logic 144 that enables the network element 140 to sample the signal from each of the optical ports 141, 142, and 143 as described by the techniques provided herein. The domain 120 also includes network element 150 with optical ports 151 and 152, and network element 160 with optical ports 161 and 162. The network elements 150 and 160 may each have port sampling logic similar to the port sampling logic 144 shown in the network element 140.

The domain 130 includes network elements 170, 180 and 190. The network element 170 includes optical ports 171, 172, 173, and 174. The network element 180 includes optical ports 181 and 182. The network element 190 includes optical ports 191, 192, 193, and 194. The network elements 170, 180, and 190 may each have port sampling logic similar to the port sampling logic 144 shown in the network element 140.

In FIG. 1, a direct connection between optical port 141 and optical port 151 connects network element 140 and network element 150. A direct connection between optical port 142 and optical port 172 connect the network element 140 and the network element 170. A direct connection between the optical port 143 and optical port 161 connects network element 140 and network element 160.

Similarly, a direct connection between optical port 152 and optical port 171 connects network element 150 and network element 170. A direct connection between optical port 162 and optical port 191 connects network element 160 and network element 190. Additionally, a direct connection between optical port 173 and optical port 192 connects network element 170 and network element 190. A direct connection between optical port 174 and optical port 181 connects network element 170 and network element 180. A direct connection between optical port 182 and optical port 194 connects network element 180 and network element 190. The optical port 193 is not connected to any port shown in FIG. 1.

In one example, the network elements 140, 150, 160, 170, 180, and 190 may also have additional ports (e.g., optical ports or non-optical ports) that are not shown in FIG. 1. Additionally, the domain 120 and/or the domain 130 may include additional network elements that are not shown in FIG. 1.

In another example, the connection discovery/verification logic 115 configures the hierarchical controller 110 to request subscribed nodes (e.g., network elements 140, 150, 160, 170, 180, and 190) to sample the signals at their respective optical ports at a predetermined time. All of the nodes may be connected to a Network Time Protocol (NTP) server that ensures that the predetermined time specified by the hierarchical controller 110 is synchronized across all of the nodes. The techniques described herein do not require high time precision as long as the nodes are sampled at a relatively low frequency (e.g., 1 kHz) and for a long enough time (e.g., 10 seconds). NTP time synchronization provides sufficient precision for typical network deployments, but the system may implement a more precise time synchronization protocol as part of the techniques described herein.

In response to the request from the hierarchical controller 110, the network elements sample the optical signals on some or all of their respective optical ports at the predetermined time. In some instances, the hierarchical controller 110 may only request signal samples from specific optical ports (e.g., ports connecting the optical domain to the IP domain). After sampling the optical signal, each network element sends the measurement results back to the hierarchical controller 110. The hierarchical controller 110 calculates a cross-correlation between each pair of sampled signals and determines which optical ports are directly connected by the maximum correlation of the signals shared by connected optical ports.

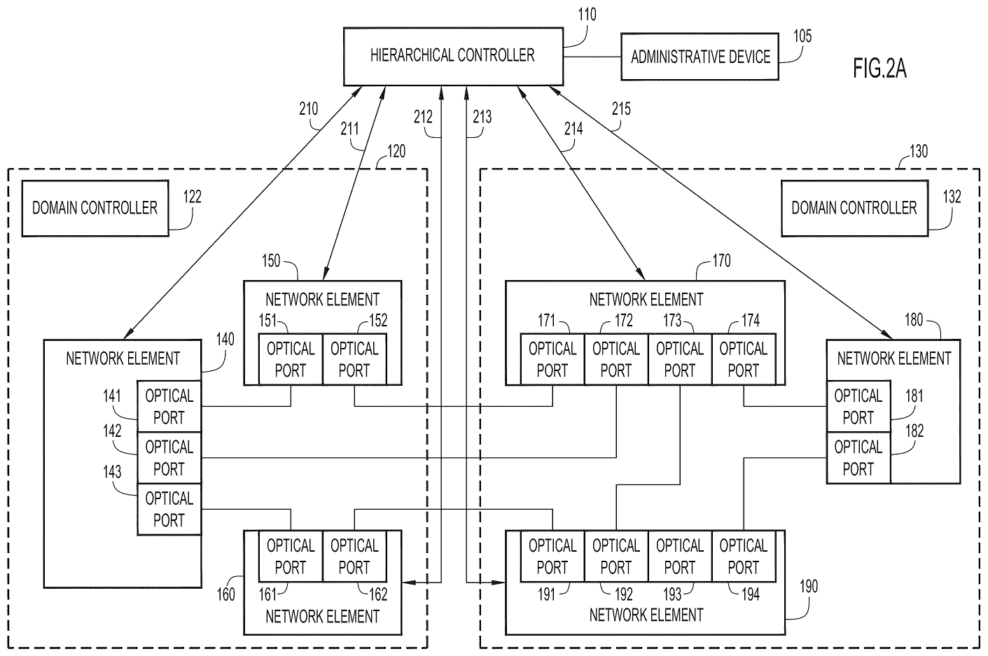

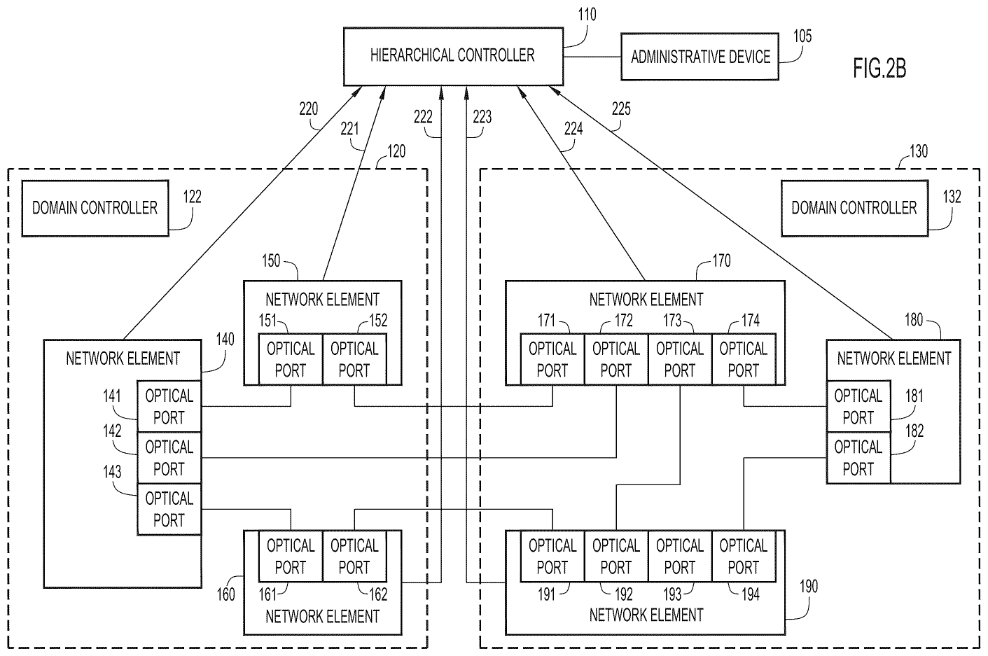

Referring now to FIG. 2A, a simplified diagram shows the hierarchical controller 110 configuring the automatic connection discovery/verification process with the network elements 140, 150, 160, 170, 180, and 190. The hierarchical controller 110 schedules a signal sampling at a predetermined time by sending out a measurement schedule and receiving an acknowledgement from each network element. The hierarchical controller 110 sends the measurement schedule to the network element 140 and receives an acknowledgement in an exchange 210 with the network element 140. Similarly, the hierarchical controller 110 sends the measurement schedule to the network elements 150, 160, 170, 180, and 190 and receives acknowledgements in exchanges 211, 212, 213, 214, and 215, respectively. In one example, the exchanges 210-215 may be mediated through the respective domain controllers (e.g., domain controller 122 and domain controller 132).

At the predetermined time included in the measurement schedule, each network element (e.g., network elements 140, 150, 160, 170, 180, and 190) samples the signal from some or all of the optical ports present on the network elements. In one example, the measurement schedule may also include an indication of which optical ports to measure. For instance, for a connection verification process, the hierarchical controller 110 may only request sample measurements from optical ports that are supposed to be connected according to a predetermined plan that is being verified. Alternatively, the hierarchical controller 110 may only request sample measurements from optical ports that are designated for inter-domain connections.

In another example, the sample measurements may comprise the power read by photodiodes associated with each optical port. For instance, the spectrum components of an optical signal may be measured with photodiodes that are also used for measuring the sampled signal requested by the hierarchical controller 110.

Referring now to FIG. 2B, a simplified block diagram illustrates each network element providing the measurement results to the hierarchical controller 110. After the network element 140 independently samples the signal from optical ports 141, 142, and 143, the network element 140 provides the measurement results 220 to the hierarchical controller 110. Similarly, after the network elements 150, 160, 170, 180, and 190 independently sample the signals from their respective optical ports, the network elements 150, 160, 170, 180, and 190 provide the measurement results 221, 222, 223, 224, and 225 to the hierarchical controller 110. In one example, the domain controller 122 and/or the domain controller 132 may relay the measurement results 220-225 from the network elements to the hierarchical controller 110.

After the hierarchical controller 110 obtains all of the measurement results from the network elements 140, 150, 160, 170, 180, and 190, the hierarchical controller 110 calculates a cross-correlation for each pair of sampled signals to verify which pairs of sampled signals provide the maximum cross-correlation peak. Any optical ports that are directly connected will be measuring the same signal at the predetermined time, and the cross-correlation peak between connected optical ports will be significantly higher than cross-correlation peaks between disconnected optical ports that sampled different signals at the predetermined time. In other words, every measurement result is cross-correlated with every other measurement, and any pairs of measurement results that have a high cross-correlation peak are determined to correspond to optical ports that are directly connected.

Based on the calculated cross-correlation peaks and the determination of directly connected optical ports, the hierarchical controller 110 may generate a connectivity map for all of the ports and all of the network elements. The hierarchical controller 110 may provide the connectivity map to the administrative device 105 to enable an administrator to verify the connections. Alternatively, the hierarchical controller 110 and the administrative device 105 may have overlapping responsibility for calculating the cross-correlation values, generating the connectivity map, and/or making adjustments to the network elements.

In one example, the sampled signals may be pre-processed before the hierarchical controller 110 calculates the cross-correlation peaks. For instance, the hierarchical controller 110 may remove a DC component of the sampled signal, which is the equivalent of high pass filtering the sampled signal. Alternatively, one or more of the network elements 140, 150, 160, 170, 180, and/or 190 may pre-process the sampled signal before providing it to the hierarchical controller 110.

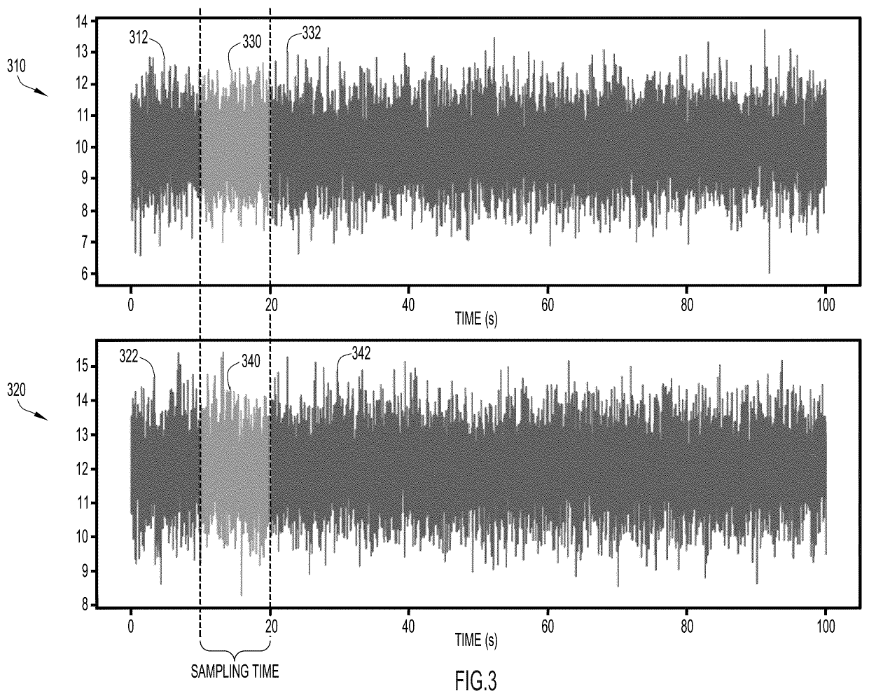

Referring now to FIG. 3, a pair of time-synchronized graphs illustrate the sampled portions of optical signals from two optical ports. The graph 310 illustrates a first optical signal 312 that is captured over 100 seconds from a first optical port. The graph 320 illustrates a second optical signal 322 that is captured over the same 100 seconds from a second optical port. The first optical port and the second optical port may be on the same network element or different network elements.

At the designated time (t=10 s), the network element with the first optical port samples the optical signal 312 to measure a sampled signal 330. The network element captures the sampled signal 330 at the predetermined time according to predetermined parameters (e.g., 1 kHz sampling rate, 10 second duration, 10,000 samples, etc.). The graph 310 shows that after the end of the sampling period, the optical signal at the first optical port continues as optical signal 332.

Similarly, the network element with the second optical port samples the optical signal 322 at the predetermined time (t=10 s) to measure a sampled signal 340. The network element captures the sampled signal 340 according to the same predetermined parameters as the sampled signal 330. The graph 320 shows that after the end of the sampling period, the optical signal at the second optical port continues as optical signal 342.

After the network element(s) capture the sampled signals 330 and 340, the sampled signals 330 and 340 are provided to a centralized controller (e.g., hierarchical controller 110). In one example, the network element(s) may pre-process the sampled signals 330 and 340 before providing them to the centralized controller. For instance, the network element may remove a DC component from the sampled signals 330 by subtracting the average value of the sampled signal 330 from each individual sampled value in the sampled signal 330. The network element that measured the sampled signal 340 may perform similar pre-processing on the sampled signal 340 before providing the measurement result to the centralized controller.

The centralized controller calculates a cross-correlation between the sampled signals 330 and 340 to determine whether the first optical port is connected to the second optical port. The centralized controller may also obtain sampled signals from other optical ports in the same or different network elements to determine whether the first optical port or the second optical port are connected to one of the other optical ports. In one example, the centralized controller may pre-process the sampled signals 330 and 340 before calculating the cross-correlation. For instance, if the network element(s) have not removed the DC component of the sampled signals 330 and 340, then the centralized controller may do so.

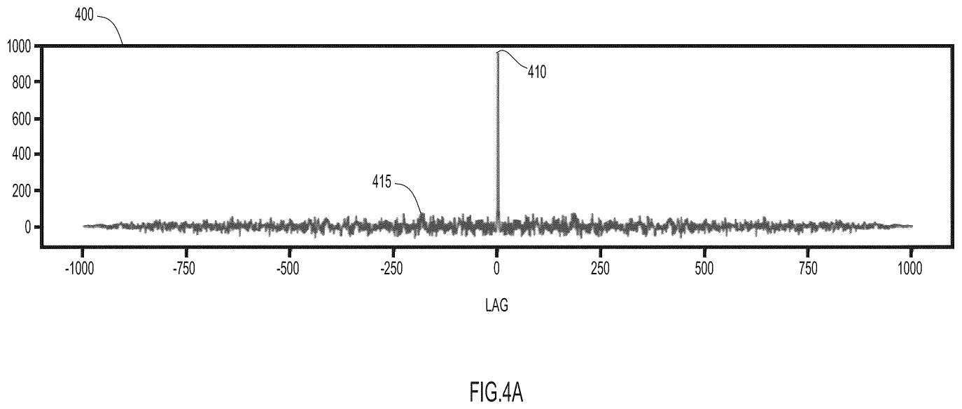

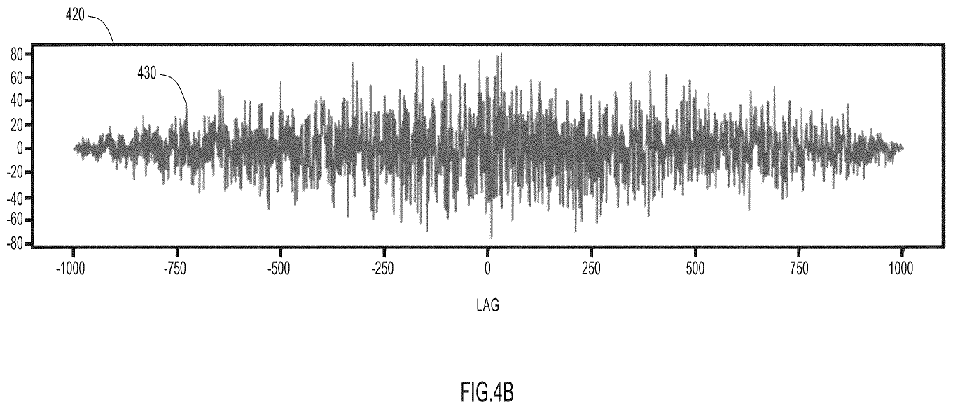

Referring now to FIG. 4A, a graph 400 illustrates a cross-correlation between sampled signals of two connected optical ports. If two optical ports are connected, then the variation in the sampled signals measured at each end of the connection should be essentially identical apart from noise in the measurement itself. The graph 400 shows that cross-correlating two sampled signals from connected optical ports results in a large peak 410 above a noisy floor 415. The peak 410 is at lag of Δt=0. In other words, the two essentially identical signals sampled from the connected optical ports were measured at the same time. If the time synchronization between the network elements of the connected optical ports was off, then the peak 410 would be further away from the point where the lag Δt=0.

Referring now to FIG. 4B, a graph 420 illustrates a cross-correlation between sampled signals of two optical ports that are not connected to each other. Since the two optical ports are not connected, the two sampled signals are essentially random and uncorrelated with each other. The graph 420 shows only the noisy floor 430 without a significant peak, and indicates that the two sampled signals are from optical ports that are not connected to each other. The noisy floor 430 shown in FIG. 4B is approximately the same magnitude as the noisy floor 415 shown in FIG. 4A.

In one example, a centralized controller (e.g., hierarchical controller 110) may determine whether two optical ports are connected based on the maximum peak value of the cross-correlation of sampled signals measured from the two optical ports. As shown in FIG. 4A, the ratio between the peak 410 and the noisy floor 415 may be on the order of 10:1. In contrast, the maximum cross-correlation peak in FIG. 4B is on the same order of magnitude as the noisy floor 430. The difference in the maximum peak of the cross-correlation provides a clear criterion for determining whether two optical ports are connected or disconnected. Alternatively, the centralized controller may calculate the integral sum of the cross-correlation signal to determine whether the corresponding optical signals are connected or disconnected.

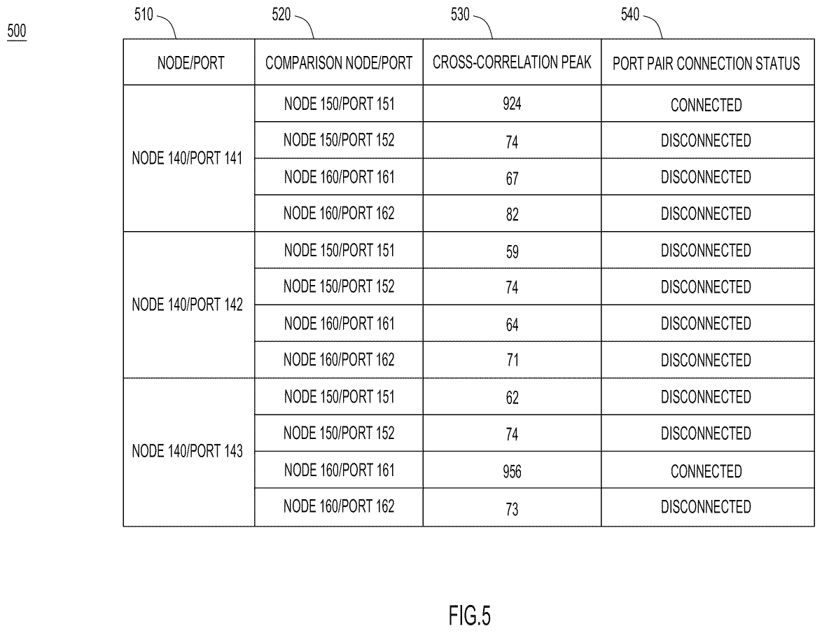

Referring now to FIG. 5, a chart 500 illustrates how a centralized controller (e.g., hierarchical controller 110 shown in FIG. 1) automatically discovers which ports and network elements/nodes are connected based on cross-correlating measurement results sampled from pairs of optical ports. The chart 500 includes a node/port column 510 with entries that identify one of the ports that corresponds to one of the sampled signal measurement results in each cross-correlation calculation. The node/port column 510 shown in FIG. 5 include entries from three ports of a single network node (e.g., optical ports 141, 142, and 143 of network element 140). The comparison node/port column 520 includes entries that identify the port that corresponds to the other sampled signal measurement result in each cross-correlation calculation. The comparison node/port column 520 shown in FIG. 5 includes entries that compares each of the entries in the node/port column 510 to ports from two different nodes (e.g., optical ports 151 and 152 of network element 150 and optical ports 161 and 162 of network element 160).

The cross-correlation peak column 530 includes entries that indicate the maximum cross-correlation peak for each combination of sampled signal measurement results from a node/port entry listed in column 510 and a node/port entry listed in column 520. The cross-correlation peak column 530 includes two entries with relatively large values (e.g., 924 or 956) in comparison to the other values (e.g., between 59 and 82). The chart 500 includes a port pair connection status column 540 with entries that indicate whether the node/ports indicated in the corresponding entries from node/port column 510 and comparison node/port column 520 are connected based on the cross-correlation peak column 530. The port pair connection status column 540 shown in FIG. 5 includes entries that indicate that optical port 141 of network element 140 is connected to optical port 151 of network element 150 and that optical port 143 of network element 140 is connected to optical port 161 of network element 160, as shown in FIG. 1.

In one example, the centralized controller may improve the sensitivity of the cross-correlation by increasing the number of samples measured during the sampling period. The centralized controller may specify parameters that increase the length of the sampling period and/or increase the sampling frequency of the sampled signal.

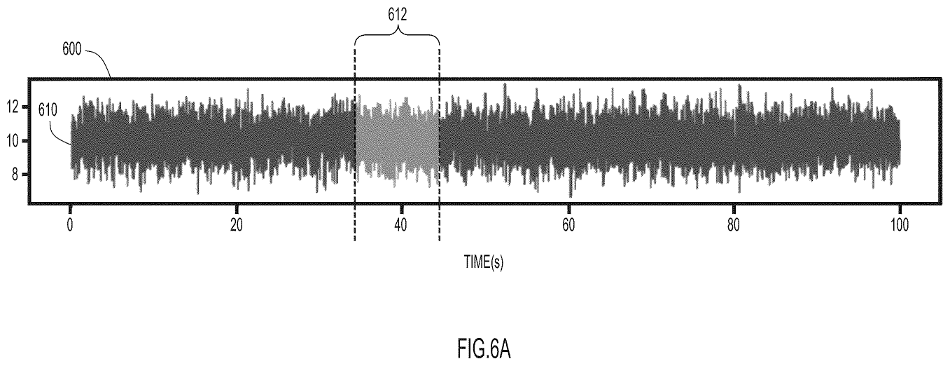

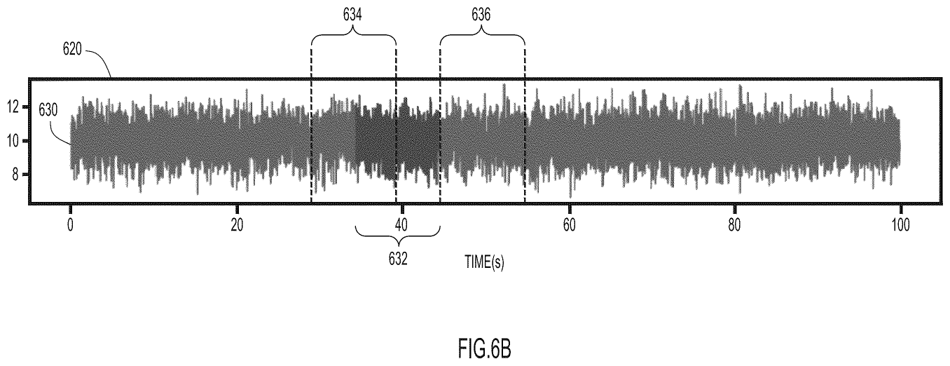

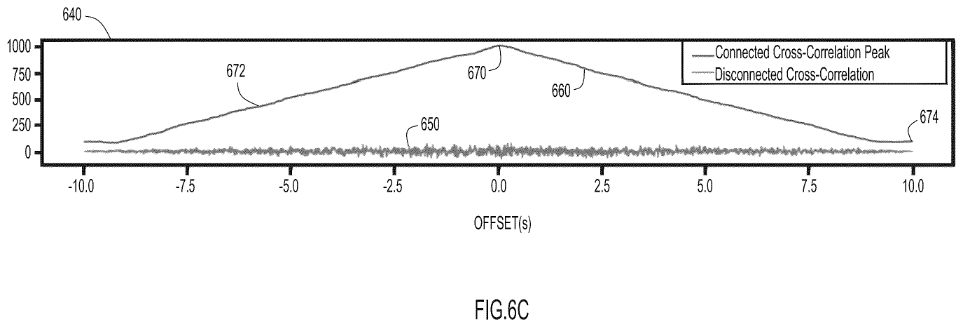

Referring now to FIG. 6A, FIG. 6B, and FIG. 6C, the effect of start timing errors between sampled signals measured from two different optical ports on the maximum cross-correlation peak is displayed. FIG. 6A includes a graph 600 that shows 100 seconds of a signal 610 that is measured from a first optical port. A first sampled portion 612 is measured from the signal 610 starting at a predetermined time (e.g., t=35 seconds) for a predetermined length of time (e.g., 10 seconds) at a predetermined sampling frequency (e.g., 1 kHz). FIG. 6B includes a graph 620 that shows 100 seconds of a signal 630 that is measured from a second optical port that is connected to the first optical port. Since the first optical port and the second optical port are connected, the signal 610 shown in FIG. 6A and the signal 630 shown in FIG. 6B match.

If the timing of sampling the signals 610 and 630 are accurately synchronized, then the first sampled portion 612 of the signal 610 will match a second sampled portion 632 of the signal 630. However, if the timing is not accurately synchronized then the sampling period of the second signal 630 may not match the sampling period of the first signal 610. For instance, if the clock on the network element with the second optical port is five seconds faster than the clock on the network element with the first optical port, then the second optical port will be represented by a third sampled portion 634 of the signal 630, which overlaps with the second sampled portion 632. Similarly, if the clock on the network element with the second optical port is ten seconds slower than the clock on the network element with the first optical port, then the second optical port will be represented by a fourth sampled portion 636 of the signal 630. The fourth sampled portion 636 does not overlap with the second sampled portion 632 and is essentially uncorrelated with the first sampled portion 612 from the first optical port despite the connection between the first optical port and the second optical port.

Referring now to FIG. 6C, a graph 640 illustrates a range of timing offsets between sampled portions and the effect on the cross-correlation peak value. The graph 640 includes the cross-correlation peak values 650 for disconnected optical ports and the cross-correlation peak values 660 for connected optical ports as a function of the timing offset between the sampled portions of the signals from the optical ports. The cross-correlation peak values 650 for disconnected optical ports are included to show the noise floor of the measurement results, since the two sampled portions of signals from disconnected optical ports are uncorrelated. The cross-correlation peak values 660 are all slightly artificially offset in the vertical axis from the cross-correlation peak values 650 for clarity. The slight offset is visible most clearly at large offset values (e.g., 10 seconds) where the cross-correlation peak values 660 of connected ports and the cross-correlation peak values 660 of disconnected ports should both be approximately zero, since the sampled signals would be uncorrelated.

The cross-correlation peak values 660 for connected optical ports, such as the first optical port and the second optical port shown in FIG. 6A and FIG. 6B, has a maximum peak value 670 when the timing offset is zero. In other words, when the two sampled portions of connected optical ports are accurately measured at the same time, then they are very well correlated. As the timing offset increases in either direction, the maximum peak value decreases linearly as the amount of correlated overlap in the sampled portions decreases until the timing offset reaches close to the length of the entire sampling period of ten seconds.

The peak value 672 shows the cross-correlation peak when one sampled portion (e.g., the third sampled portion 634 in FIG. 6B) has a five second lag over the other sampled portion (e.g., the first sampled portion 612 in FIG. 6A). Similarly, the peak value 674 shows the cross-correlation peak when one sampled portion (e.g., the fourth sampled portion 636 in FIG. 6B) has a ten second lead over the other sampled portion (e.g., the first sampled portion 612 in FIG. 6A).

The cross-correlation peak values 660 show the effect of timing offsets between two measurements for two connected ports. When the offset is zero, the cross-correlation is at the maximum peak value 670. As the offset diverges from zero, in either direction, the cross-correlation peak values 660 decrease. The graph 640 illustrates that, for reasonable offsets (e.g., less than 5 seconds), the difference between the cross-correlation peak values 660 of connected ports and the cross-correlation peak values 650 of unconnected ports remains high enough to provide a clear criterion for determining the connection status of the associated ports. The graph 640 confirms that, in practical implementations that are not perfectly synchronized, the techniques presented herein tolerate reasonable timing offsets between measurements of sampled signals from ports.

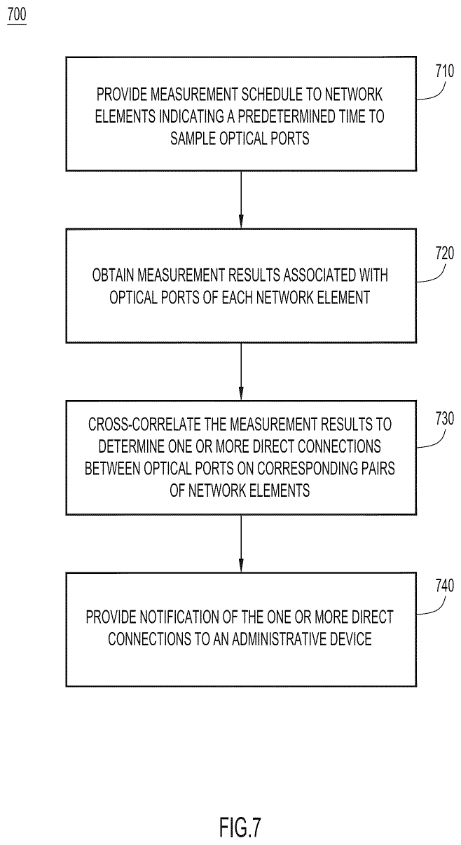

Referring now to FIG. 7, a flowchart illustrates an example process 700 performed by a centralized controller (e.g., hierarchical controller 110) to automatically discover connections between optical ports. At 710, the centralized controller provides a measurement schedule to a plurality of network elements. The measurement schedule indicates a predetermined time that all of the network elements are directed to sample signals from one or more optical ports. In one example, the network elements include clocks that are synchronized (e.g., via an NTP server). In another example, the centralized controller also provides parameters (e.g., sampling frequency and duration) for each network element to sample their respective optical ports.

At 720, the centralized controller obtains measurement results of the sampled signals from optical ports of each network element. In one example, the measurement results are obtained from the network elements through one or more domain controllers. At 730, the centralized controller cross-correlates the measurement results to determine one or more direct connections between optical ports on corresponding pairs of network elements. In one example, the centralized controller calculates the cross-correlation between measurement results of sampled signals from specified pairs of optical ports to verify a predetermined network configuration. Alternatively, the centralized controller may cross-correlate each measurement result against all of the other measurement results to discover any connections between two optical ports.

At 740, the centralized controller provides a notification of the one or more direct connections to an administrative device. In one example, the administrative device may enable an administrator to view a connectivity map of the one or more direct connections. Additionally, the administrative device may be combined with the centralized controller.

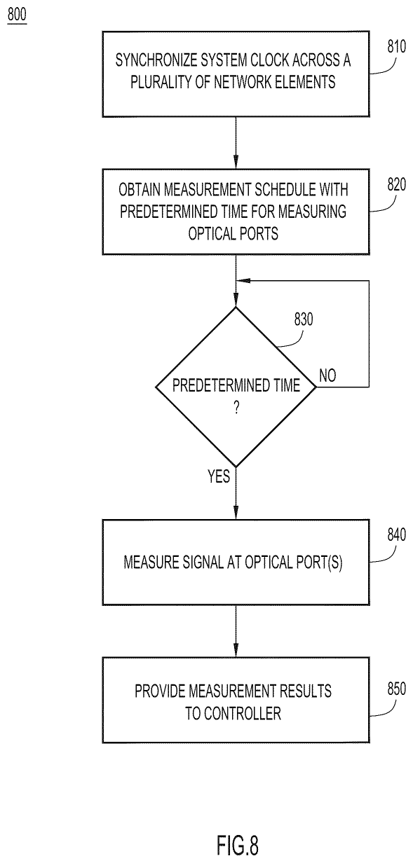

Referring now to FIG. 8, a flowchart illustrates an example, process 800 performed by a network element to sample a signal from one or more optical ports to enable a centralized controller to automatically discover/verify direct connections of the one or more optical ports. At 810, the network element synchronizes a system clock with system clocks of a plurality of network elements. In one example, the system clocks of all of the network elements are synchronized through an NTP server communicatively connected to each network element in the plurality of network elements.

At 820, the network element obtains a measurement schedule with a predetermined time for measuring optical ports on the network element. In one example, the measurement schedule may be provided by a centralized controller or a domain controller. In another example, the network element may also obtain predetermined parameters, such as sampling frequency and duration, for sampling the signal of the one or more optical ports.

At the predetermined time, as determined at 830, the network element measures the signal at one or more optical ports on the network element at 840. In one example, the network element may sample a photodiode associated with each optical port that is configured to be measured. The sampled measurements may be processed, e.g., by an Analog-to-Digital Converter (ADC), after being measured. At 850, the measurement results of the sampled signals from the one or more optical ports are provided to a centralized controller, which cross-correlates the measurement results from each of the network elements to discover direct connections of the one or more optical ports. In one example, the measurement results may be provided to the centralized controller through a domain controller of a network domain to which the network element belongs.

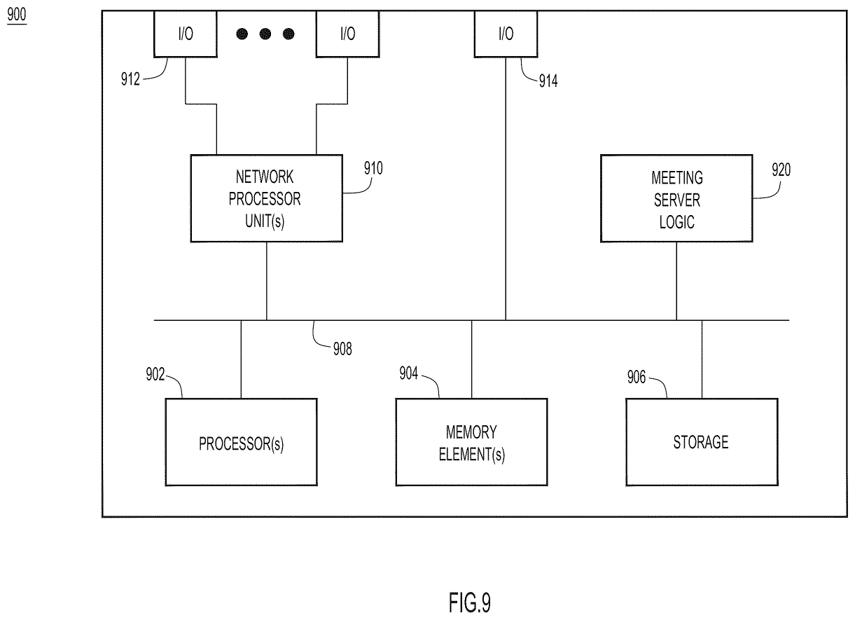

Referring to FIG. 9, FIG. 9 illustrates a hardware block diagram of a computing device 900 that may perform functions associated with operations discussed herein in connection with the techniques depicted in FIGS. 1, 2A, 2B, 3, 4A, 4B, 5, 6A-6C, 7, and 8. In various embodiments, a computing device, such as computing device 900 or any combination of computing devices 900, may be configured as any entity/entities as discussed for the techniques depicted in connection with FIGS. 1, 2A, 2B, 3, 4A, 4B, 5, 6A-6C, 7, and 8 in order to perform operations of the various techniques discussed herein.

In at least one embodiment, the computing device 900 may include one or more processor(s) 902, one or more memory element(s) 904, storage 906, a bus 908, one or more network processor unit(s) 910 interconnected with one or more network input/output (I/O) interface(s) 912, one or more I/O interface(s) 914, and control logic 920. In various embodiments, instructions associated with logic for computing device 900 can overlap in any manner and are not limited to the specific allocation of instructions and/or operations described herein.

In at least one embodiment, processor(s) 902 is/are at least one hardware processor configured to execute various tasks, operations and/or functions for computing device 900 as described herein according to software and/or instructions configured for computing device 900. Processor(s) 902 (e.g., a hardware processor) can execute any type of instructions associated with data to achieve the operations detailed herein. In one example, processor(s) 902 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 904 and/or storage 906 is/are configured to store data, information, software, and/or instructions associated with computing device 900, and/or logic configured for memory element(s) 904 and/or storage 906. For example, any logic described herein (e.g., control logic 920) can, in various embodiments, be stored for computing device 900 using any combination of memory element(s) 904 and/or storage 906. Note that in some embodiments, storage 906 can be consolidated with memory element(s) 904 (or vice versa), or can overlap/exist in any other suitable manner.

In at least one embodiment, bus 908 can be configured as an interface that enables one or more elements of computing device 900 to communicate in order to exchange information and/or data. Bus 908 can be implemented with any architecture designed for passing control, data and/or information between processors, memory elements/storage, peripheral devices, and/or any other hardware and/or software components that may be configured for computing device 900. In at least one embodiment, bus 908 may be implemented as a fast kernel-hosted interconnect, potentially using shared memory between processes (e.g., logic), which can enable efficient communication paths between the processes.

In various embodiments, network processor unit(s) 910 may enable communication between computing device 900 and other systems, entities, etc., via network I/O interface(s) 912 (wired and/or wireless) to facilitate operations discussed for various embodiments described herein. In various embodiments, network processor unit(s) 910 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 900 and other systems, entities, etc. to facilitate operations for various embodiments described herein. In various embodiments, network I/O interface(s) 912 can be configured as one or more Ethernet port(s), Fibre Channel ports, any other I/O port(s), and/or antenna(s)/antenna array(s) now known or hereafter developed. Thus, the network processor unit(s) 910 and/or network I/O interface(s) 912 may include suitable interfaces for receiving, transmitting, and/or otherwise communicating data and/or information in a network environment.

I/O interface(s) 914 allow for input and output of data and/or information with other entities that may be connected to computing device 900. For example, I/O interface(s) 914 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 920 can include instructions that, when executed, cause processor(s) 902 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 920) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 904 and/or storage 906 can store data, software, code, instructions (e.g., processor instructions), logic, parameters, combinations thereof, and/or the like used for operations described herein. This includes memory element(s) 904 and/or storage 906 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In summary, the techniques presented herein provide for automatically determining the connection status of optical network ports. A centralized controller instructs each network element with optical ports to sample the signal from each optical port at the same time. The centralized controller collects the sampled signals from each network element and cross-correlates the sampled signals to determine which optical ports are directly connected. Any optical ports that are directly connected to each other will measure the same optical signal, which provides a high degree of cross-correlation in the sampled signal.

The optical ports may be sampled without taking the network element offline, and no special signals are required to be injected into the optical ports. Additionally, the hardware for sampling the signal in the optical ports is existing hardware that may be temporarily repurposed for the automatic connectivity discovery system. Furthermore, the existing processing hardware on each network element may be sufficient to measure the sampled signal without specialized hardware. The sampling parameters allow the signal sampling without significantly affecting the normal operation of the network element.

The automatic connectivity discovery system may be used for connection verification or connection discovery. For connection verification, a predetermined cabling plan defines which ports should be connected, and the automatic connectivity system verifies the implementation of the predetermined cabling plan when appropriate (e.g., after installation or repair of a network system). In some cases, the centralized controller may only cross-correlate sampled signals from ports that should be connected according to the predetermined cabling plan to verify specific connections. Alternatively, if the centralized controller does not have a predetermined cabling plan, then the centralized controller may operate for connection discovery and cross-correlate all of the sampled signals from all of the ports.

In some aspects, the techniques described herein relate to a method including: providing a measurement schedule to a plurality of network elements, the measurement schedule indicating a predetermined time to sample optical ports of each network element in the plurality of network elements; obtaining a plurality of measurement results from the plurality of network elements, each particular measurement result of the plurality of measurement results associated with a particular optical port of a particular network element among the plurality of network elements; cross-correlating the plurality of measurement results to determine one or more direct connections between optical ports on corresponding pairs of network elements among the plurality of network elements; and providing a notification to at least one administrative device, the notification indicating the one or more direct connections.

In some aspects, the techniques described herein relate to a method, further including obtaining a list of registered optical ports from the plurality of network elements.

In some aspects, the techniques described herein relate to a method, wherein the measurement schedule includes the list of registered optical ports.

In some aspects, the techniques described herein relate to a method, wherein the plurality of network elements includes one or more Software Defined Networking (SDN) domains.

In some aspects, the techniques described herein relate to a method, wherein the measurement schedule is provided to the plurality of network elements through one or more domain controllers corresponding to the one or more SDN domains.

In some aspects, the techniques described herein relate to a method, wherein the plurality of measurement results are obtained from the plurality of network elements through one or more domain controllers corresponding to the one or more SDN domains.

In some aspects, the techniques described herein relate to a method, wherein the measurement schedule indicates parameters for the plurality of network elements to sample the optical ports.

In some aspects, the techniques described herein relate to an apparatus including: a network interface configured to communicate with computing devices in one or more computer networks; and a processor coupled to the network interface, the processor configured to: cause the network interface to provide a measurement schedule to a plurality of network elements, the measurement schedule indicating a predetermined time to sample optical ports of each network element in the plurality of network elements; obtain a plurality of measurement results from the plurality of network elements via the network interface, each particular measurement result of the plurality of measurement results associated with a particular optical port of a particular network element among the plurality of network elements; cross-correlate the plurality of measurement results to determine one or more direct connections between optical ports on corresponding pairs of network elements among the plurality of network elements; and cause the network interface to provide a notification to at least one administrative device, the notification indicating the one or more direct connections.

In some aspects, the techniques described herein relate to an apparatus, wherein the processor is further configured to obtain a list of registered optical ports from the plurality of network elements via the network interface.

In some aspects, the techniques described herein relate to an apparatus, wherein the measurement schedule includes the list of registered optical ports.

In some aspects, the techniques described herein relate to an apparatus, wherein the plurality of network elements includes one or more Software Defined Networking (SDN) domains.

In some aspects, the techniques described herein relate to an apparatus, wherein the network interface is configured to provide the measurement schedule to the plurality of network elements through one or more domain controllers corresponding to the one or more SDN domains.

In some aspects, the techniques described herein relate to an apparatus, wherein the network interface is configured to obtain the plurality of measurement results from the plurality of network elements through one or more domain controllers corresponding to the one or more SDN domains.

In some aspects, the techniques described herein relate to an apparatus, wherein the measurement schedule indicates parameters for the plurality of network elements to sample the optical ports.

In some aspects, the techniques described herein relate to one or more non-transitory computer readable storage media encoded with software including computer executable instructions that, when the software is executed on a computing device, is operable to cause a processor of the computing device to: provide a measurement schedule to a plurality of network elements, the measurement schedule indicating a predetermined time to sample optical ports of each network element in the plurality of network elements; obtain a plurality of measurement results from the plurality of network elements, each particular measurement result of the plurality of measurement results associated with a particular optical port of a particular network element among the plurality of network elements; cross-correlate the plurality of measurement results to determine one or more direct connections between optical ports on corresponding pairs of network elements among the plurality of network elements; and provide a notification to at least one administrative device, the notification indicating the one or more direct connections.

In some aspects, the techniques described herein relate to one or more non-transitory computer readable storage media, wherein the software is further operable to cause the processor to obtain a list of registered optical ports from the plurality of network elements.

In some aspects, the techniques described herein relate to one or more non-transitory computer readable storage media, wherein the software is further operable to cause the processor to include the list of registered optical ports with the measurement schedule.

In some aspects, the techniques described herein relate to one or more non-transitory computer readable storage media, wherein the plurality of network elements includes one or more Software Defined Networking (SDN) domains.

In some aspects, the techniques described herein relate to one or more non-transitory computer readable storage media, wherein the software is further operable to cause the processor to provide the measurement schedule to the plurality of network elements through one or more domain controllers corresponding to the one or more SDN domains.

In some aspects, the techniques described herein relate to one or more non-transitory computer readable storage media, wherein the software is further operable to cause the processor to obtain the plurality of measurement results from the plurality of network elements through one or more domain controllers corresponding to the one or more SDN domains.

Each example embodiment disclosed herein has been included to present one or more different features. However, all disclosed example embodiments are designed to work together as part of a single larger system or method. The disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
providing a measurement schedule to a plurality of network elements, the measurement schedule indicating a predetermined time to sample optical ports of each network element in the plurality of network elements;
obtaining a plurality of measurement results from the plurality of network elements, each particular measurement result of the plurality of measurement results associated with a particular optical port of a particular network element among the plurality of network elements;
cross-correlating the plurality of measurement results to determine one or more direct connections between optical ports on corresponding pairs of network elements among the plurality of network elements; and
providing a notification to at least one administrative device, the notification indicating the one or more direct connections.

2. The method of claim 1, further comprising obtaining a list of registered optical ports from the plurality of network elements.

3. The method of claim 2, wherein the measurement schedule includes the list of registered optical ports.

4. The method of claim 1, wherein the plurality of network elements comprises one or more Software Defined Networking (SDN) domains.

5. The method of claim 4, wherein the measurement schedule is provided to the plurality of network elements through one or more domain controllers corresponding to the one or more SDN domains.

6. The method of claim 4, wherein the plurality of measurement results is obtained from the plurality of network elements through one or more domain controllers corresponding to the one or more SDN domains.

7. The method of claim 1, wherein the measurement schedule indicates parameters for the plurality of network elements to sample the optical ports.

8. An apparatus comprising:
a network interface configured to communicate with computing devices in one or more computer networks; and
a processor coupled to the network interface, the processor configured to:
cause the network interface to provide a measurement schedule to a plurality of network elements, the measurement schedule indicating a predetermined time to sample optical ports of each network element in the plurality of network elements;
obtain a plurality of measurement results from the plurality of network elements via the network interface, each particular measurement result of the plurality of measurement results associated with a particular optical port of a particular network element among the plurality of network elements;
cross-correlate the plurality of measurement results to determine one or more direct connections between optical ports on corresponding pairs of network elements among the plurality of network elements; and
cause the network interface to provide a notification to at least one administrative device, the notification indicating the one or more direct connections.

9. The apparatus of claim 8, wherein the processor is further configured to obtain a list of registered optical ports from the plurality of network elements via the network interface.

10. The apparatus of claim 9, wherein the measurement schedule includes the list of registered optical ports.

11. The apparatus of claim 8, wherein the plurality of network elements comprises one or more Software Defined Networking (SDN) domains.

12. The apparatus of claim 11, wherein the network interface is configured to provide the measurement schedule to the plurality of network elements through one or more domain controllers corresponding to the one or more SDN domains.

13. The apparatus of claim 11, wherein the network interface is configured to obtain the plurality of measurement results from the plurality of network elements through one or more domain controllers corresponding to the one or more SDN domains.

14. The apparatus of claim 8, wherein the measurement schedule indicates parameters for the plurality of network elements to sample the optical ports.

15. One or more non-transitory computer readable storage media encoded with software comprising computer executable instructions that, when the software is executed on a computing device, is operable to cause a processor of the computing device to:
provide a measurement schedule to a plurality of network elements, the measurement schedule indicating a predetermined time to sample optical ports of each network element in the plurality of network elements;
obtain a plurality of measurement results from the plurality of network elements, each particular measurement result of the plurality of measurement results associated with a particular optical port of a particular network element among the plurality of network elements;
cross-correlate the plurality of measurement results to determine one or more direct connections between optical ports on corresponding pairs of network elements among the plurality of network elements; and
provide a notification to at least one administrative device, the notification indicating the one or more direct connections.

16. The one or more non-transitory computer readable storage media of claim 15, wherein the software is further operable to cause the processor to obtain a list of registered optical ports from the plurality of network elements.

17. The one or more non-transitory computer readable storage media of claim 16, wherein the software is further operable to cause the processor to include the list of registered optical ports with the measurement schedule.

18. The one or more non-transitory computer readable storage media of claim 15, wherein the plurality of network elements comprises one or more Software Defined Networking (SDN) domains.

19. The one or more non-transitory computer readable storage media of claim 18, wherein the software is further operable to cause the processor to provide the measurement schedule to the plurality of network elements through one or more domain controllers corresponding to the one or more SDN domains.

20. The one or more non-transitory computer readable storage media of claim 18, wherein the software is further operable to cause the processor to obtain the plurality of measurement results from the plurality of network elements through one or more domain controllers corresponding to the one or more SDN domains.
